(19) United States
(12) Patent Application Publication
(10) Pub. No.: US 2026/0120936 A1
(43) Pub. Date: Apr. 30, 2026

(54) SYSTEM INCLUDING A TRANSFORMER

(71) Applicant: Hitachi Energy Ltd, Zürich (CH)

(72) Inventors: Thomas Gradinger, Aarau Rohr (CH); Stephane Isler, Faucigny (FR); Victor Manuel Garcia, Zaragoza (ES); Marko Mogorovic, Geneva (CH); Valter Porcellato, Gland, Vaud (CH)

(21) Appl. No.: 19/151,713

(22) PCT Filed: Feb. 9, 2023
(86) PCT No.: PCT/EP2023/053209

§ 371 Date: Jul. 29, 2025

(30) Foreign Application Priority Data
Feb. 3, 2023 (EP) 23382098.4

(51) Int. Cl. H01F 27/12; H01F 27/02

(52) U.S. Cl. CPC H01F 27/12; H01F 27/02

(57) ABSTRACT

The present disclosure relates to a system including a transformer which includes a tank configured to receive a liquid. The system further includes an overflow device and a connection device configured to fluidically connect the tank and the overflow device. The overflow device includes a flexible member which is elastically deformable. The overflow device is configured to periodically receive a portion of the liquid from the tank under deformation of the flexible member and return at least a portion of the received liquid to the tank through the connection device. The system further includes a heat transfer device configured to provide a flow of a cooling medium at at least a portion of the overflow device and/or the connection device.

### CROSS REFERENCE TO RELATED APPLICATIONS

This application is a 35 U.S.C. § 371 national stage application of International Application No. PCT/EP2023/053209 filed on Feb. 9, 2023, which in turn claims foreign priority to European Patent Application No. 23382098.4 filed on Feb. 3, 2023, the disclosures and content of which are incorporated by reference herein in their entirety.

### BACKGROUND

Transformers are widely used to convert electricity from a first voltage level to a second voltage level, the second voltage level being either similar, higher or lower than the first voltage level. A transformer generally achieves such a voltage conversion by employing one or more windings which include electrical conductors and are wound around a core of the transformer by a plurality of turns.

Transformers may be provided with one or more liquids for various reasons. For instance, some transformers include an insulating liquid, in particular an insulating oil, for insulating the transformer. In particular, the insulating liquid may be arranged in a tank together with the core and winding(s) of the transformer to immerse the core and winding(s) in the insulating liquid. Such transformers are often referred to as liquid-immersed transformers. However, additionally or alternatively, one or more further liquids may be employed in a transformer for various other purposes.

Moreover, transformers may generate a considerable amount of heat during operation which may increase the temperature of the liquid(s) within the transformer. Alternatively, or additionally, the temperature of the liquid(s) may be increased due to one or more ambient conditions, such as an increased temperature of the environment in the respective transformer is arranged. Hence, the temperature of the liquid(s) may fluctuate. An increase in the temperature of the liquid(s) may decrease the density of the liquid(s) which may cause the liquid(s) to expand. To cope with such an expansion of the liquid(s), some transformers known from the prior art include an expansion vessel configured to compensate for an expansion of the liquid(s).

However, the expansion vessels known from the prior art have several drawbacks. For instance, the expansion vessels known from the prior art are relatively bulky and/or consume a relatively large amount of space. Moreover, the expansion vessels often have a relatively complex construction and/or are often operated in a relatively complex manner, e.g., by utilizing one or more air cushions in the respective expansion vessels. Moreover, at least some of the expansion vessels known from the prior art are prone to damage and/or failure.

Thus, the present disclosure describes one or more aspects for providing enhanced means for coping with an expansion of liquid(s) in a transformer, as detailed below.

The present disclosure relates to a system according to a first aspect of the disclosure.

According to a second aspect and a third aspect of the disclosure, further systems are described in the present disclosure, respectively.

Various exemplary embodiments of the present disclosure disclosed herein are directed to providing features that will become readily apparent by reference to the following description when taken in conjunction with the accompanying drawings. In accordance with various embodiments, exemplary devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. The above and other aspects and their implementations are described in greater detail in the drawings, the descriptions, and the claims.

### DESCRIPTION OF THE DRAWINGS

FIG. 1 schematically shows, in a cross-sectional view, a system according to an embodiment of the present disclosure;

FIG. 2 schematically shows, in a cross-sectional view, a system according to a further embodiment of the present disclosure;

FIG. 3 schematically shows, in a cross-sectional view, a system according to a further embodiment of the present disclosure;

FIG. 4 schematically shows, in a cross-sectional view, a system according to a further embodiment of the present disclosure;

FIG. 5 schematically shows, in a cross-sectional view, a system according to a further embodiment of the present disclosure;

FIG. 6 schematically shows, in a cross-sectional view, a system according to a further embodiment of the present disclosure;

FIG. 7 schematically shows, in a cross-sectional view, a system according to a further embodiment of the present disclosure;

FIG. 8 schematically shows, in a cross-sectional view, a system according to a further embodiment of the present disclosure;

FIG. 9 schematically shows, in a cross-sectional view, a system according to a further embodiment of the present disclosure;

FIG. 10 schematically shows, in a cross-sectional view, a system according to a further embodiment of the present disclosure.

In the following, exemplary embodiments of the disclosure will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

The system according to the first aspect of the disclosure may include at least one transformer which may include at least one tank configured to at least partially receive at least one core and at least one winding wound at least partially about the at least one core. The at least one tank may be configured to at least partially receive at least one liquid, e.g., an insulating liquid and/or a cooling liquid.

The system may further include at least one overflow device and at least a first connection device configured to fluidically connect the at least one tank and the at least one overflow device. The at least one overflow device may include at least one flexible member which is elastically deformable. The at least one overflow device may be configured to periodically, in particular at least during expansion of the liquid in the at least one tank, receive a portion of the liquid from the at least one tank, under deformation of at least a portion of the at least one flexible member, and return at least a portion of the received liquid to the at least one tank through the connection device.

The system may further include at least one heat transfer device configured to provide at least one flow of at least one cooling medium at at least a portion of the at least one overflow device and/or the connection device to increase heat transfer from the liquid therein to the cooling medium.

As discussed at the beginning, one or more liquids arranged within a transformer may periodically expand, e.g., during operation of the transformer, e.g., due to fluctuations in the temperature of the liquid, e.g., due to heat generated by the transformer during operation. Hence, the at least one overflow device described above may receive and accommodate at least a portion of the respective liquid from the tank of the transformer via the connection device, in particular as the liquid expands. Hence, the at least one overflow device effectively may provide an additional volume, in particular a variable additional volume, to receive and accommodate at least a portion of the respective liquid from the tank of the transformer via the connection device, in particular as the liquid expands. This may, for instance, prevent damage to the transformer due to an increase in pressure of the liquid as the liquid expands in the at least one tank.

The at least one flexible member may provide a variable liquid storage volume in the at least one overflow device, e.g., by being elastically deformed as the at least one overflow device receives liquid from the at least one tank to increase a liquid storage volume in the at least one overflow device. As the density of the liquid increases again, e.g., due to a decrease in temperature of the liquid, the at least one flexible member may at least partially return to its pre-deformed state to decrease a liquid storage volume in the at least one overflow device. The at least one flexible member may be configured to urge at least a portion of the liquid received in the at least one overflow device to return to the at least one tank as the at least one flexible member at least partially returns to its pre-deformed state.

Configuring the system such that at least a portion of the liquid from the at least one tank is received by the at least one overflow device and is at least partially returned to the at least one tank through the same (first) connection device, i.e., along substantially the same flow path through the same conduit(s), may reduce the space required by the at least one overflow device and the connection device, which may provide a relatively compact construction of the system. In other words, a flow of direction of the liquid through the (first) connection device from the overflow device to the at least one tank may be reversed with respect to a flow of direction of the liquid through the same (first) connection device from the at least one tank to the overflow device. The liquid may flow through the (first) connection device in a first direction of flow from the at least one tank to the overflow device and may flow through the same (first) connection device in a second direction of flow, which is substantially opposite to the first direction of flow, from the overflow device to the at least one tank.

The at least one overflow device may accommodate or house at least a portion of the liquid throughout the operation of the transformer/system, or at least for a large part of the operation of the transformer/system. Hence, the language that the at least one overflow device may be configured to “receive a portion of the liquid from the at least one tank” may mean that additional liquid is received by the at least one overflow device from the at least one tank.

Configuring the system with the at least one heat transfer device configured to provide at least one flow of at least one cooling medium at at least a portion of the at least one overflow device and/or the connection device may increase at least one heat transfer coefficient between the at least one overflow device and/or the connection device and the cooling medium, respectively, to enhance cooling of the liquid in the at least one overflow device and/or the connection device to reduce the temperature of the liquid. This may provide more favorable thermal conditions, e.g., reduced temperatures, at the at least one overflow device, in particular the at least one flexible member. For instance, this may allow a greater flexibility in selecting a material for manufacturing the at least one flexible member. Many materials which are used to manufacture flexible and elastically deformable members are limited in their tolerance of increased temperatures. Thus, exposing the respective flexible member to temperatures which are near or above a respective tolerance threshold temperature of the respective flexible member may result in damage and/or deterioration of the respective flexible member. Hence, decreasing the temperature of the liquid by means of the at least one heat transfer device may prevent, or at least reduce the risk of, damage to the at least one flexible member and/or may increase the lifetime of the at least one flexible member.

Reducing an exposure of the flexible member to higher temperature and/or reducing the temperature of the liquid which the flexible member is exposed to may also reduce a rate of permeation of gases, e.g., oxygen, and/or liquids, e.g., water, through the flexible member, e.g., into the liquid.

Configuring the at least one heat transfer device to provide at least one flow of at least one cooling medium at at least a portion of the at least one overflow device and/or the connection device may provide a cooling means for cooling the liquid at a relatively high efficiency and/or effectiveness and/or in an individualized manner. For instance, a degree of heat transfer from the liquid to the at least one cooling medium may be adjusted/adapted by configuring the flow of at least one cooling medium, e.g., by increasing or decreasing a flow rate of the flow, by adjusting a direction of the flow, in particular relative to the at least one overflow device and/or the connection device, by adjusting a temperature of the at least one cooling medium of the flow, by selecting the at least one cooling medium according to one or more properties of the at least one cooling medium, by adjusting a degree of turbulence of the flow, etc. In general, the flow may be configured such that an interaction between the flow and the at least one overflow device and/or the connection device, respectively, may provide one or more desired heat transfer coefficients between the flow and the at least one overflow device and/or the connection device.

The at least one heat transfer device may be configured to direct the flow towards at least one outer surface of the at least one overflow device and/or the connection device, i.e., at least one surface of the at least one overflow device and/or the connection device which is arranged substantially opposite to at least one contact surface of the at least one overflow device and/or the connection device which is in contact with and/or faces the liquid during operation of the system.

The at least one heat transfer device may be configured to generate a forced convection of the at least one flow. For instance, the system may include one or more mechanical devices, e.g., at least one pump, at least one ventilator, at least one fan, at least one compressor, etc., configured to increase and/or decrease a pressure in the at least one cooling medium to move the at least one cooling medium.

The at least one cooling medium may be any medium which is suitable to transfer heat from the liquid to cooling medium. For instance, the at least one cooling medium may be a liquid, e.g., water or a mixture including water and glycol, and/or a gas, e.g., air, e.g., ambient air.

The above-recited language that the connection device is configured to “fluidically connect the at least one tank and the at least one overflow device” may mean that the fluidical connection between the at least one tank and the at least one overflow device allows the liquid to be transferred at least partially between the at least one tank and the at least one overflow device via the connection device.

The at least one flexible member may be configured to allow at least one shape and/or at least dimension of at least a section of the at least one flexible member to be changed, in particular passively, in particular as the liquid is being receiving by the at least one overflow device and/or is being returned to the at least one tank from the at least one overflow device. The change in the shape and/ dimension(s) of the at least one flexible member may result in an increase and/or a decrease in a liquid storage volume within the at least one overflow device. The term “deform” may mean any type of alteration of at least one shape and/or at least dimension of at least a section of the at least one flexible member. This may include flexing, bending, expanding, contracting, collapsing, deflection, stretching, shrinking, elongating, etc. of the at least one flexible member. Since the at least one flexible member may be configured to be elastically deformable, the at least one flexible member may be configured to be deformed from a first state to a second state and may at least partially return to the first state and/or vice versa, e.g., when a volume of the liquid received within the at least one overflow device is changed, e.g., is increased or decreased.

The at least one flexible member may be configured to receive at least a portion of the liquid from the at least one tank by at least partially being deformed, in particular expanded, from a first state to a second state. The at least one flexible member may be configured to at least partially return from the second state to the first state as at least a portion of the liquid is returned from the at least one overflow device to the at least one tank. The at least one flexible member may be configured to urge the liquid to return to the at least one tank as the at least one flexible member at least partially returns from the second state to the first state. The liquid may be any type of liquid and/or for any purpose and/or function, e.g., insulation, cooling, etc. For instance, the liquid may be an oil. The liquid may be an insulation liquid, e.g., an insulation oil, configured to insulate at least a portion of the at least one winding and/or at least a portion of the at least one core of the transformer. In other words, the transformer may be configured as liquid-immersed transformer in which the at least one core and/or the at least one winding may be at least partially, in particular completely, immersed in the liquid.

The at least one flexible member may be made of any type of flexible material, e.g., a polymeric material. In particular, the at least one flexible member may be made of a flexible material which has a lower tolerance with respect to increased temperatures than the materials used in at least some of the expansion vessels known from the prior art, since the temperature of the liquid may be reduced by means of the at least one heat transfer device.

The connection device may be configured as, or may at least include, a conduit for guiding the liquid between the at least one tank and the at least one overflow device.

The overflow device may be configured such that, when at least a portion of the liquid is received by the overflow device, the liquid is in direct contact with the at least one flexible member. In other words, the liquid received by the at least one overflow device may be in fluidical communication/connection, i.e., in direct contact, with the flexible member. This may eliminate or at least reduce empty space, i.e., hollow spaces within the overflow device, when at least a portion of the liquid is received by the overflow device. This may save space and provide a relatively compact build to the overflow device, relative to the available liquid storage space in the overflow device for storing the liquid. This may allow the overflow device to be installed in applications in which the installation space is limited, e.g., for traction transformers, and/or in which a relatively compact installation is advantageous. As discussed at the beginning, many expansion vessels known from the prior art include one or more air cushions. Such air cushions reduce the available liquid storage space in the overflow device for storing the liquid for a given size of the respective expansion vessel. Moreover, this may result in a relatively bulky construction.

The at least one flexible member may be configured as a barrier between the liquid and an environment. For instance, the at least one flexible member may be configured as a membrane. The “environment” may be an ambient, or at least a space which is fluidically connected with the ambient, or a closed, e.g., hermetically closed, space. In case the environment is a closed, e.g., hermetically closed, space, the space may be filled with a gas, e.g., nitrogen.

The at least one flexible member may include at least one flexible member wall which defines a lumen configured to receive at least a portion of the liquid from the at least one tank. For instance, the at least one flexible member may be configured as a bladder or a pouch. Hence, the at least one flexible member may be deformable/expandable in that the liquid exerts a force against an inner surface of the at least one flexible member wall, when at least a portion of the liquid is received in the overflow device.

The system may further include at least one guiding device configured to guide the at least one cooling medium to at least a portion of the at least one overflow device and/or the connection device. This may increase the effectiveness and/or efficiency of the heat transfer from the liquid to the at least one cooling medium, i.e., by concentrating and/or directing the at least one cooling medium to at least a portion of the at least one overflow device and/or the connection device to provide a relatively large degree of interaction between the at least one cooling medium and the at least one overflow device and/or the connection device, respectively. The at least one guiding device may be configured as any type of structure configured to direct the at least one cooling medium to at least a portion of the at least one overflow device and/or the connection device. For instance, the at least one guiding device may include one or more conduits configured to convey the at least one cooling medium and guide the at least one cooling medium to at least a portion of the at least one overflow device and/or the connection device. The at least one guiding device may include at least one (cooling) circuit, which may include one or more conduits, for guiding the at least one cooling medium to and away from the connection device and/or the connection device. The at least one circuit may be fluidically connected to at least one heat exchanger, e.g., a shell and tube heat exchanger or a plate heat exchanger, e.g., to transfer heat from the at least one cooling medium to a further medium. The circuit may be configured as an open circuit or a closed circuit, e.g., to recirculate the cooling medium.

The at least one heat transfer device may be configured to convey the at least one cooling medium along the connection device in and/or against a direction in which the liquid is transferred between the at least one tank and the at least one overflow device. This may provide a relatively high heat transfer coefficient between the cooling medium and the connection device which may provide a relatively large degree of heat transfer from the liquid to the at least one cooling medium, e.g., compared with a configuration in which the at least one cooling medium is conveyed in a direction which is non-parallel, e.g., perpendicular, to a direction in which the liquid is transferred between the at least one tank and the at least one overflow device. In particular, the at least one heat transfer device may be configured to convey the at least one cooling medium along the connection device against a direction in which the liquid is transferred from the at least one tank to the at least one overflow device. This may provide a relatively high heat transfer coefficient between the cooling medium and the connection device, e.g., compared with a configuration in which the at least one cooling medium is conveyed in a direction in which the liquid is transferred from the at least one tank to the at least one overflow device. This may provide a relatively large cooling effect to the liquid, as the liquid is flowing from the at least one tank to the at least one overflow device.

The system may further include one or more protrusions, in particular one or more fins, which extend from at least one surface of the connection device and/or the at least one overflow device. The one or more protrusions may be configured to conduct heat to and/or from the connection device and/or the at least one overflow device to increase heat dissipation from the liquid. This may increase the area for conducting heat to and/or from the connection device and/or the at least one overflow device. This may further reduce a temperature of the liquid within the connection device in and/or the at least one overflow device.

The system may further include one or more deflectors configured to deflect the liquid and/or the at least one cooling medium on an exterior of the at least one overflow device and/or on an exterior of the connection device and/or within the at least one overflow device and/or within the connection device. This may (further) increase the heat transfer between the liquid and the at least one cooling medium to further reduce a temperature of the liquid within the connection device in and/or the at least one overflow device.

The connection device may be configured as a conduit which is guided in a coiled and/or meandering manner in at least a section thereof. This may increase an outer surface of the connection device, more specifically of the conduit, which may increase the heat transfer between the liquid and the at least one cooling medium to further reduce a temperature of the liquid within the connection device.

The at least one heat transfer device may include at least one cooling circuit configured to guide the at least one cooling medium to and/or away from the connection device and/or the at least one overflow device.

The connection device may be fluidically connected to the at least one tank at a section of the at least one tank which is arranged to at least one side of the tank, in particular towards the bottom of the at least one tank. In particular, the connection device may be fluidically connected to the at least one tank at a section of the at least one tank which is arranged no higher than a transverse central axis of the at least one tank, in particular no higher than midway between a bottom of the at least one tank and the transverse central axis of the at least one tank. This may allow cooler portions of the liquid in the at least one tank to flow to the at least one overflow device, since the liquid in the at least one tank generally cooler at the sides, in particular at the bottom, of the at least one tank, e.g., due to stratification of the liquid in the at least one tank. Stratification of the liquid in the at least one tank may be greater, if the liquid is limited to natural convection within the at least one tank, compared with forced convection of the liquid within the at least one tank, e.g., via a mixer and/or a pump. Thus, while the above-described effect may be used for natural convection and forced convection of the liquid within the at least one tank, the effect may be greater for natural convection.

The connection device may be fluidically connected to the at least one tank at a section of the at least one tank which is arranged no higher than 50% of a liquid fill level of the tank, in particular no higher than 40% of a liquid fill level of the tank, in particular no higher than 30% of a liquid fill level of the tank, in particular no higher than 20% of a liquid fill level of the tank, in particular no higher than 10% of a liquid fill level of the tank.

The system may further include at least one thermal conduction reducing device which includes at least one thermal conduction reducing material configured to reduce thermal conduction between the at least one tank and the at least one overflow device. The at least one thermal conduction reducing device may include at least one thermal conduction reducing material which is arranged in at least a section of the connection device. The at least one thermal conduction reducing material may have a lower thermal conductivity than an adjacent material of the connection device. This may reduce the amount of heat which is conducted from the at least one tank to the at least one overflow device. This may further reduce a temperature of the liquid within the connection device in and/or the at least one overflow device.

The system may further include at least one buffer vessel which is in fluidical connection with the at least one tank and the at least one overflow device. The at least one buffer vessel may be arranged such that the liquid which is transferred from the at least one tank to the at least one overflow device is received by the at least one buffer vessel before being received by the at least one overflow device. The at least one buffer vessel may further reduce the temperature of the liquid which is applied to the at least one flexible member. In particular, the at least one buffer vessel may increase a heat transfer area for transferring heat from the liquid to and ambient and/or to the at least cooling medium. Alternatively, or additionally, the at least one buffer vessel may store a portion of the liquid, referred to as a “buffer liquid”, which essentially remains outside of the at least one tank during operation of the transformer, at least during extended periods or during the entire duration of the operation of the transformer. This may allow the buffer liquid to remain relatively cool such that, as the liquid within the at least one tank expands, the buffer liquid is pushed into the at least one overflow device by liquid flowing from the at least one tank towards the at least one overflow device. This may allow the cooler buffer liquid to contact, at least for the large part and/or at least initially, the at least one flexible member and may prevent or at least limit exposure of the at least one flexible member to the hotter liquid flowing from the at least one tank towards the at least one overflow device. This may prevent, or at least reduce the risk of, damage to the at least one flexible member and/or may increase the lifetime of the at least one flexible member.

The at least one buffer vessel may be substantially rigid. Thus, in contrast to the at least one flexible member, the at least one buffer vessel may not be deformed/expanded by the liquid. In other words, the at least one buffer vessel may have a fixed liquid storage volume for storing at least a portion of the liquid.

The transformer may be configured as any type of transformer. For instance, the transformer may be configured as a traction transformer, in particular for use on a railway vehicle, in particular to provide power to the railway vehicle.

The system, in particular the at least one overflow device and/or the connection device, may be free of a hygroscopic substance, in particular a desiccant.

A further system according to a second aspect of the present disclosure is described below. The system according to the first aspect and the system according to the second aspect may be combined or may be provided separately.

The system may include at least one transformer which may include at least one tank configured to at least partially receive at least one core and at least one winding wound at least partially about the at least one core. The at least one tank may be configured to at least partially receive at least one liquid, e.g., an insulating liquid and/or a cooling liquid.

The system may further include at least one overflow device and at least a first connection device configured to fluidically connect the at least one tank and the at least one overflow device. The at least one overflow device may include at least one flexible member which is elastically deformable. The at least one overflow device may be configured to periodically receive a portion of the liquid from the at least one tank under deformation of at least a portion of the at least one flexible member and return at least a portion of the received liquid to the at least one tank through the connection device.

The system may further include at least one surface increasing means configured to provide an increase in an area of a heat transfer surface of the connection device across which heat may be dissipated from the liquid. The at least one surface increasing means may include one or more protrusions, in particular one or more fins. The one or more protrusions may extend from at least one surface of the connection device. The one or more protrusions may be configured to conduct heat to and/or from the connection device.

Alternatively, or additionally, the connection device may be configured as a conduit which is guided in a coiled and/or meandering manner in at least a section thereof.

Alternatively, or additionally, the connection device may be configured as a conduit which has a total effective length of at least 25 cm.

Providing the at least one surface increasing means described above, e.g., by including one or more protrusions, in particular one or more fins, by configuring the connection device as a conduit which is guided in a coiled and/or meandering manner in at least a section thereof and/or by configuring the connection device as a conduit which has a total effective length of at least 25 cm, may increase heat dissipation from the liquid via the connection device, e.g., to at least one cooling medium and/or to an ambient, by increasing an area of a heat transfer surface of the connection device across which heat may be dissipated from the liquid to reduce the temperature of the liquid. This may provide more favorable thermal conditions at the at least one overflow device, in particular the at least one flexible member, as discussed above with respect to the first aspect.

The term “total effective length” means a total length of the conduit along which the liquid flows. In other words, a “total effective length” means a total length of an equivalent straight conduit in which the liquid travels the same distance as the actual, e.g., non-straight, e.g., bent, straight, coiled, meandered, etc., conduit.

The at least one surface of the connection device, from which the one or more protrusions may extend, may include an outer surface and/or an inner surface of the connection device. The system may include one or more deflectors configured to deflect the liquid within the connection device and/or to deflect at least one cooling medium on an exterior of the connection device. The one or more deflectors may be arranged and configured to impart one or more forces onto the liquid to direct and/or redirect the at least one cooling medium towards an exterior of the connection device. This may enhance the effectiveness and/or efficiency of the cooling medium in cooling the liquid.

The conduit may have a total effective length of at least 30 cm, more particularly at least 40 cm, more particularly at least 50 cm, more particularly at least 60 cm, more particularly at least 70 cm, more particularly at least 80 cm, more particularly at least 90 cm, more particularly at least 100 cm, more particularly at least 110 cm, more particularly at least 120 cm, more particularly at least 130 cm, more particularly at least 140 cm, more particularly at least 150 cm, more particularly at least 160 cm, more particularly at least 170 cm, more particularly at least 180 cm, more particularly at least 190 cm, more particularly at least 200 cm.

A further system according to a third aspect of the present disclosure is described below. The system according to the first aspect and/or the system according to the second aspect and/or the system according to the third aspect may be combined or may be provided separately.

The system may include at least one transformer which may include at least one tank configured to at least partially receive at least one core and at least one winding wound at least partially about the at least one core. The at least one tank may be configured to at least partially receive at least one liquid, e.g., an insulating liquid and/or a cooling liquid.

The system may further include at least one overflow device and at least a first connection device configured to fluidically connect the at least one tank and the at least one overflow device. The at least one overflow device may include at least one flexible member which is elastically deformable. The overflow device may be configured to periodically receive a portion of the liquid from the at least one tank under deformation of at least a portion of the flexible member and return at least a portion of the received liquid to the at least one tank through the connection device.

The system may further include at least one cooling device which may include at least one phase-change material. The at least one cooling device may be arranged in thermal communication with the connection device liquid to dissipate heat from the liquid to the at least one phase-change material, when the liquid is received in the connection device.

Providing the at least one cooling device may increase heat dissipation from the liquid by increasing a temperature difference between the liquid and a heat sink of the at least one cooling device, i.e., the at least one phase-change material. This may increase heat dissipation from the liquid to reduce the temperature of the liquid. This may provide more favorable thermal conditions at the at least one overflow device, as discussed with respect to the first aspect above.

The above and other aspects and their implementations are described in greater detail in the drawings, the descriptions, and the claims.

The following list of aspects provides alternative and/or further features of the disclosure:
1. A system, including:
   at least one transformer which includes at least one tank configured to at least partially receive at least one liquid;
   at least one overflow device and at least a first connection device configured to fluidically connect the at least one tank and the at least one overflow device, the at least one overflow device including at least one flexible member which is elastically deformable, the at least one overflow device being configured to periodically receive a portion of the liquid from the at least one tank under deformation of at least a portion of the flexible member and return at least a portion of the received liquid to the at least one tank through the connection device; and
   at least one heat transfer device configured to provide at least one flow of at least one cooling medium at at least a portion of the at least one overflow device and/or the connection device to increase heat transfer from the liquid therein to the cooling medium.
2. The system according to aspect 1, wherein the overflow device is configured such that, when at least a portion of the liquid is received by the overflow device, the liquid is in direct contact with the flexible member.
3. The system according to aspect 1 or 2, wherein the flexible member is configured as a barrier between the liquid and an environment.
4. The system according to any of the preceding aspects, wherein the flexible member includes at least one flexible member wall which defines a lumen configured to receive at least a portion of the liquid from the at least one tank.
5. The system according to any of the preceding aspects, wherein the at least one heat transfer device includes at least one guiding device configured to guide the at least one cooling medium to at least a portion of the at least one overflow device and/or the connection device.
6. The system according to any of the preceding aspects, wherein the at least one heat transfer device is configured to convey the at least one cooling medium along the connection device in and/or against a direction in which the liquid is transferred from the at least one tank to the at least one overflow device.
7. The system according to any of the preceding aspects, wherein the liquid is an oil.
8. The system according to any of the preceding aspects, further including one or more protrusions, in particular one or more fins, which extend from at least one surface of the connection device and/or the at least one overflow device, wherein the one or more protrusions are configured to conduct heat to and/or from the connection device and/or the at least one overflow device to increase heat dissipation from the liquid.
9. The system according to any of the preceding aspects, further including one or more deflectors configured to deflect the liquid and/or the at least one cooling medium on an exterior of the at least one overflow device and/or on an exterior of the connection device and/or within the at least one overflow device and/or within the connection device.
10. The system according to any of the preceding aspects, wherein the connection device is configured as a conduit which is guided in a coiled and/or meandering manner in at least a section thereof.
11. The system according to any of the preceding aspects, wherein the at least one heat transfer device includes at least one cooling circuit configured to guide the at least one cooling medium to and away from the connection device and/or the at least one overflow device.
12. The system according to any of the preceding aspects, wherein the connection device is fluidically connected to the at least one tank at a section of the at least one tank which is arranged to at least one side of the tank, in particular towards the bottom of the at least one tank.
13. The system according to any of the preceding aspects, wherein the connection device is fluidically connected to the at least one tank at a section of the at least one tank which is arranged no higher than 50% of a liquid fill level of the tank, in particular no higher than 40% of a liquid fill level of the tank, in particular no higher than 30% of a liquid fill level of the tank, in particular no higher than 20% of a liquid fill level of the tank, in particular no higher than 10% of a liquid fill level of the tank.
14. The system according to any of the preceding aspects, further including at least one thermal conduction reducing device which includes at least one thermal conduction reducing material configured to reduce thermal conduction between the at least one tank and the at least one overflow device, in particular wherein the at least one thermal conduction reducing device includes at least one thermal conduction reducing material which is arranged in at least a section of the connection device, wherein the at least one thermal conduction reducing material has a lower thermal conductivity than an adjacent material of the connection device.
15. The system according to any of the preceding aspects, further including at least one buffer vessel which is in fluidical connection with the at least one tank and the at least one overflow device, wherein the at least one buffer vessel is arranged such that the liquid which is transferred from the at least one tank to the at least one overflow device is received by the at least one buffer vessel before being received by the at least one overflow device.
16. The system according to aspect 15, wherein the at least one buffer vessel is substantially rigid.
17. The system according to any of the preceding aspects, wherein the transformer is configured as a traction transformer, in particular for use on a railway vehicle, in particular to provide power to the railway vehicle.
18. The system according to any of the preceding aspects, wherein the system is free of a hygroscopic substance, in particular a desiccant.
19. The system according to any of the preceding aspects, further including at least one cooling device which includes at least one phase-change material, the at least one cooling device being arranged in thermal communication with the connection device liquid to dissipate heat from the liquid to the at least one phase-change material, when the liquid is received in the connection device.
20. The system according to any of the preceding aspects, further including at least one surface increasing means configured to provide an increase in an area of a heat transfer surface of the connection device across which heat may be dissipated from the liquid by providing one or more of the following: providing one or more protrusions, in particular one or more fins, which extend from at least one surface of the connection device, configuring the connection device as a conduit which is guided in a coiled and/or meandering manner in at least a section thereof, and configuring the connection device as a conduit which has a total effective length of at least 25 cm.
21. A system, including:
   at least one transformer which includes at least one tank configured to at least partially receive at least one liquid;
   at least one overflow device and at least a first connection device configured to fluidically connect the at least one tank and the at least one overflow device, the at least one overflow device including at least one flexible member which is elastically deformable, the overflow device being configured to periodically receive a portion of the liquid from the at least one tank under deformation of at least a portion of the flexible member and return at least a portion of the received liquid to the at least one tank through the connection device; and
   at least one surface increasing means configured to provide an increase in an area of a heat transfer surface of the connection device across which heat may be dissipated from the liquid by providing one or more of the following: providing one or more protrusions, in particular one or more fins, which extend from at least one surface of the connection device, configuring the connection device as a conduit which is guided in a coiled and/or meandering manner in at least a section thereof, and configuring the connection device as a conduit which has a total effective length of at least 25 cm.
22. The system according to aspect 21, wherein the one or more protrusions are configured to conduct heat to and/or from the connection device.
23. The system according to any of aspects 21 or 22, wherein the conduit has a total effective length of at least 30 cm, more particularly at least 40 cm, more particularly at least 50 cm, more particularly at least 60 cm, more particularly at least 70 cm, more particularly at least 80 cm, more particularly at least 90 cm, more particularly at least 100 cm, more particularly at least 110 cm, more particularly at least 120 cm, more particularly at least 130 cm, more particularly at least 140 cm, more particularly at least 150 cm, more particularly at least 160 cm, more particularly at least 170 cm, more particularly at least 180 cm, more particularly at least 190 cm, more particularly at least 200 cm.
24. The system according to any of aspects 21 to 23, further including at least one heat transfer device configured to provide at least one flow of at least one cooling medium at at least a portion of the at least one overflow device and/or the connection device to increase heat transfer from the liquid therein to the cooling medium.
25. The system according to aspect 24, wherein the at least one heat transfer device includes at least one cooling circuit configured to guide the at least one cooling medium to and away from the connection device and/or the at least one overflow device.
26. The system according to aspect 24 or 25, further including at least one guiding device configured to guide the at least one cooling medium to at least a portion of the at least one overflow device and/or the connection device.
27. The system according to any of aspects 24 to 26, wherein the at least one heat transfer device is configured to convey the at least one cooling medium along the connection device in and/or against a direction in which the liquid is transferred from the at least one tank to the at least one overflow device.
28. The system according to any of aspects 21 to 27, wherein the overflow device is configured such that, when at least a portion of the liquid is received by the overflow device, the liquid is in direct contact with the flexible member.
29. The system according to any of aspects 21 to 28, wherein the flexible member is configured as a barrier between the liquid and an environment.
30. The system according to any of aspects 21 to 29, wherein the flexible member includes at least one flexible member wall which defines a lumen configured to receive at least a portion of the liquid from the at least one tank.
31. The system according to any of aspects 21 to 30, wherein the liquid is an oil.
32. The system according to any of aspects 21 to 31, further including one or more deflectors configured to deflect the liquid and/or the at least one cooling medium on an exterior of the at least one overflow device and/or on an exterior of the connection device and/or within the at least one overflow device and/or within the connection device.
33. The system according to any of aspects 21 to 32, wherein the connection device is fluidically connected to the at least one tank at a section of the at least one tank which is arranged to at least one side of the tank, in particular towards the bottom of the at least one tank.
34. The system according to any of aspects 21 to 33, wherein the connection device is fluidically connected to the at least one tank at a section of the at least one tank which is arranged no higher than 50% of a liquid fill level of the tank, in particular no higher than 40% of a liquid fill level of the tank, in particular no higher than 30% of a liquid fill level of the tank, in particular no higher than 20% of a liquid fill level of the tank, in particular no higher than 10% of a liquid fill level of the tank.
35. The system according to any of aspects 21 to 34, further including at least one thermal conduction reducing device which includes at least one thermal conduction reducing material configured to reduce thermal conduction between the at least one tank and the at least one overflow device, in particular wherein the at least one thermal conduction reducing device includes at least one thermal conduction reducing material which is arranged in at least a section of the connection device, wherein the at least one thermal conduction reducing material has a lower thermal conductivity than an adjacent material of the connection device.
36. The system according to any of aspects 21 to 35, further including at least one buffer vessel which is in fluidical connection with the at least one tank and the at least one overflow device, wherein the at least one buffer vessel is arranged such that the liquid which is transferred from the at least one tank to the at least one overflow device is received by the at least one buffer vessel before being received by the at least one overflow device.
37. The system according to aspect 36, wherein the at least one buffer vessel is substantially rigid.
38. The system according to any of aspects 21 to 37, wherein the transformer is configured as a traction transformer, in particular for use on a railway vehicle, in particular to provide power to the railway vehicle.
39. The system according to any of aspects 21 to 38, wherein the system is free of a hygroscopic substance, in particular a desiccant.
40. The system according to any of aspects 21 to 39, further including at least one cooling device which includes at least one phase-change material, the at least one cooling device being arranged in thermal communication with the connection device liquid to dissipate heat from the liquid to the at least one phase-change material, when the liquid is received in the connection device.
41. A system, including:
   at least one transformer which includes at least one tank configured to at least partially receive at least one liquid;
   at least one overflow device and at least a first connection device configured to fluidically connect the at least one tank and the at least one overflow device, the at least one overflow device including at least one flexible member which is elastically deformable, the overflow device being configured to periodically receive a portion of the liquid from the at least one tank under deformation of at least a portion of the flexible member and return at least a portion of the received liquid to the at least one tank through the connection device; and
   at least one cooling device, which optionally includes at least one phase-change material, the at least one cooling device being arranged in thermal communication with the connection device liquid to dissipate heat from the liquid to at least one cooling medium of the at least one cooling device, when the liquid is received in the connection device, the at least one cooling device optionally being configured to cool the at least one cooling medium to a temperature which is below an ambient temperature.
42. The system according to aspect 41, further including at least one heat transfer device configured to provide at least one flow of at least one cooling medium at at least a portion of the at least one overflow device and/or the connection device to increase heat transfer from the liquid therein to the cooling medium.
43. The system according to aspect 42, wherein the at least one heat transfer device includes at least one cooling circuit configured to guide the at least one cooling medium to and away from the connection device and/or the at least one overflow device.
44. The system according to aspect 42 or 43, further including at least one guiding device configured to guide the at least one cooling medium to at least a portion of the at least one overflow device and/or the connection device.
45. The system according to any of aspects 42 to 44, wherein the at least one heat transfer device is configured to convey the at least one cooling medium along the connection device in and/or against a direction in which the liquid is transferred from the at least one tank to the at least one overflow device.
46. The system according to any of aspects 41 to 45, further including at least one surface increasing means configured to provide an increase in an area of a heat transfer surface of the connection device across which heat may be dissipated from the liquid by providing one or more of the following: providing one or more protrusions, in particular one or more fins, which extend from at least one surface of the connection device, configuring the connection device as a conduit which is guided in a coiled and/or meandering manner in at least a section thereof, and configuring the connection device as a conduit which has a total effective length of at least 25 cm.
47. The system according to aspect 46, wherein the one or more protrusions are configured to conduct heat to and/or from the connection device.
48. The system according to aspect 46 or 47, wherein the conduit has a total effective length of at least 30 cm, more particularly at least 40 cm, more particularly at least 50 cm, more particularly at least 60 cm, more particularly at least 70 cm, more particularly at least 80 cm, more particularly at least 90 cm, more particularly at least 100 cm, more particularly at least 110 cm, more particularly at least 120 cm, more particularly at least 130 cm, more particularly at least 140 cm, more particularly at least 150 cm, more particularly at least 160 cm, more particularly at least 170 cm, more particularly at least 180 cm, more particularly at least 190 cm, more particularly at least 200 cm.
49. The system according to any of aspects 41 to 48, wherein the overflow device is configured such that, when at least a portion of the liquid is received by the overflow device, the liquid is in direct contact with the flexible member.
50. The system according to any of aspects 41 to 49, wherein the flexible member is configured as a barrier between the liquid and an environment.
51. The system according to any of aspects 41 to 50, wherein the flexible member includes at least one flexible member wall which defines a lumen configured to receive at least a portion of the liquid from the at least one tank.
52. The system according to any of aspects 41 to 51, wherein the liquid is an oil.
53. The system according to any of aspects 41 to 52, further including one or more deflectors configured to deflect the liquid and/or the at least one cooling medium on an exterior of the at least one overflow device and/or on an exterior of the connection device and/or within the at least one overflow device and/or the device.
54. The system according to any of aspects 41 to 53, wherein the connection device is fluidically connected to the at least one tank at a section of the at least one tank which is arranged to at least one side of the tank, in particular towards the bottom of the at least one tank.
55. The system according to any of aspects 41 to 54, wherein the connection device is fluidically connected to the at least one tank at a section of the at least one tank which is arranged no higher than 50% of a liquid fill level of the tank, in particular no higher than 40% of a liquid fill level of the tank, in particular no higher than 30% of a liquid fill level of the tank, in particular no higher than 20% of a liquid fill level of the tank, in particular no higher than 10% of a liquid fill level of the tank.
56. The system according to any of aspects 41 to 55, further including at least one thermal conduction reducing device which includes at least one thermal conduction reducing material configured to reduce thermal conduction between the at least one tank and the at least one overflow device, in particular wherein the at least one thermal conduction reducing device includes at least one thermal conduction reducing material which is arranged in at least a section of the connection device, wherein the at least one thermal conduction reducing material has a lower thermal conductivity than an adjacent material of the connection device.
57. The system according to any of aspects 41 to 56, further including at least one buffer vessel which is in fluidical connection with the at least one tank and the at least one overflow device, wherein the at least one buffer vessel is arranged such that the liquid which is transferred from the at least one tank to the at least one overflow device is received by the at least one buffer vessel before being received by the at least one overflow device.
58. The system according to aspect 57, wherein the at least one buffer vessel is substantially rigid.
59. The system according to any of aspects 41 to 58, wherein the transformer is configured as a traction transformer, in particular for use on a railway vehicle, in particular to provide power to the railway vehicle.
60. The system according to any of aspects 41 to 59, wherein the system is free of a hygroscopic substance, in particular a desiccant.
61. The system according to any of the preceding aspects, wherein the flexible member is at least partially, in particular completely, made of at least one polymeric material.

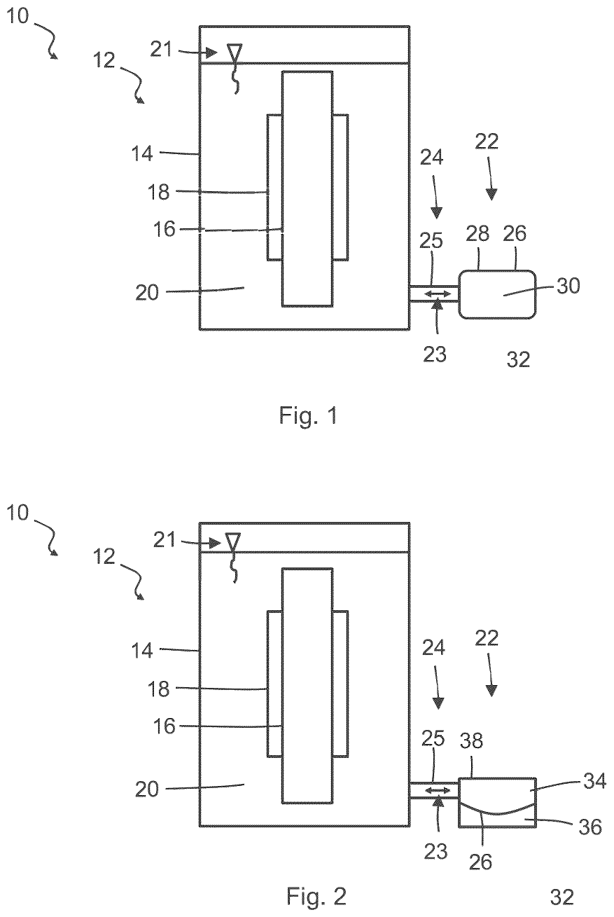

FIG. 1 schematically shows, in a cross-sectional view, a system 10 according to an embodiment of the present disclosure. The system 10 may include at least one transformer 12 which includes at least one tank 14 configured to at least partially receive at least one core 16, at least one winding 18 wound at least partially about the at least one core 16, and at least one liquid 20. An exemplary fill level 21 of the liquid 20 in the at least one tank 14 is indicated in FIG. 1. The at least one tank 14 is usually completely filled with liquid, i.e., with no air at the top of the at least one tank 14.

The system 10 may further include at least one overflow device 22 and at least a first connection device 24 configured to fluidically connect the at least one tank 14 and the at least one overflow device 22. The at least one overflow device 22 may include at least one flexible member 26 which is elastically deformable. The at least one overflow device 22 may be configured to periodically receive a portion of the liquid 20 from the at least one tank 14 under deformation of at least a portion of the flexible member 26 and return at least a portion of the received liquid 20 to the at least one tank 14 through the connection device 24, as indicated by the double-arrowed line 23 in the Figs. The connection device 24 may include at least one conduit 25 through which the fluid 20 is guided between the at least one tank 14 and the at least one overflow device 22.

As shown in the Figs., the connection device 24 may be fluidically connected to the at least one tank 14 at a section of the at least one tank 14 which is arranged on a side of the at least one tank 14, in particular towards the bottom of the at least one tank 14. However, the connection device 24 may be arranged at any other location of the at least one tank 14. For instance, the connection device 24 may be arranged towards or at the top of the at least one tank 14.

The at least one flexible member 26 may include at least one flexible member wall 28 which defines a lumen 30 configured to receive at least a portion of the liquid 20 from the at least one tank 14. The at least one flexible member 26, in particular the at least one flexible member wall 28 of the at least one flexible member 26, may be configured as a barrier between the liquid 20 received in the lumen 30 and an environment 32.

As shown in FIG. 1, the at least one flexible member 26 may be configured as a bladder or a pouch. Hence, the at least one flexible member 26 may be deformable/expandable in that the liquid 20 exerts a force an inner surface of the at least one flexible member wall 28, as the liquid 20, or more liquid, flows into the at least one overflow device 22, more specifically into the lumen 30 of the at least one flexible member 26.

FIG. 2 schematically shows, in a cross-sectional view, a variation of the system 10 according to a further embodiment of the present disclosure. In particular, in contrast to the at least one flexible member 26 shown in FIG. 1, the at least one flexible member 26 in the embodiment shown in FIG. 2 may be configured as a barrier which separates at least one liquid receiving chamber 34 of the at least one overflow device 22 from at least one expansion chamber 36 of the at least one overflow device 22, as shown in FIG. 2. In particular, the at least one overflow device 22 may include at least one housing 38 which defines the at least one liquid receiving chamber 34 and the at least one expansion chamber 36 and houses the at least one flexible member 26.

Hence, the at least one flexible member 26 may be deformable/expandable in that the liquid 20 exerts a force on a surface of the at least one flexible member 26 which faces the at least one liquid receiving chamber 34, as the liquid 20, or more liquid, flows into the at least one overflow device 22, more specifically into the at least one liquid receiving chamber 34. Thus, the at least one flexible member 26 may increase or decrease a volume of the at least one liquid receiving chamber 34 and the at least one expansion chamber 36 by changing the shape, i.e., deforming, the at least one flexible member 26, as the liquid 20, or more liquid, flows into the at least one overflow device 22, more specifically into the at least one liquid receiving chamber 34. The at least one expansion chamber 36 may be substantially closed, in particular hermetically closed, to the environment 32.

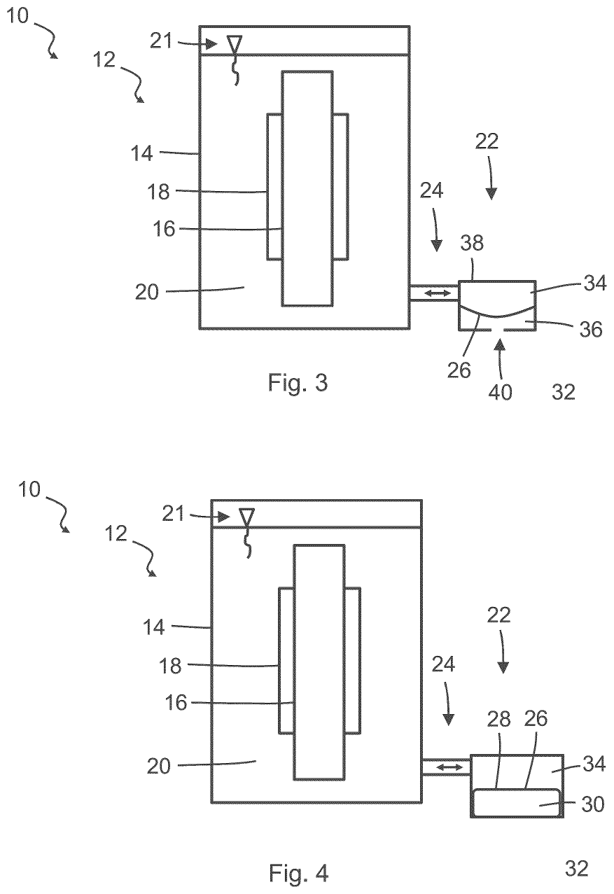

FIG. 3 schematically shows, in a cross-sectional view, a further variation of the system 10 according to a further embodiment of the present disclosure. The embodiment shown in FIG. 3 is similar to the embodiment shown in FIG. 2. However, in contrast to the embodiment shown in FIG. 2, the at least one expansion chamber 36 of the embodiment shown in FIG. 3 may be open to the environment 32 via at least one opening 40.

FIG. 4 schematically shows, in a cross-sectional view, yet a further variation of the system 10 according to a further embodiment of the present disclosure. Similar to the embodiment shown in FIG. 1, the at least one flexible member 26 may include at least one flexible member wall 28 which defines a lumen 30. The at least one overflow device 22 may include at least one liquid receiving chamber 34, similar to the embodiment of FIG. 1. However, in contrast to the embodiment shown in FIG. 1, the lumen 30 may be configured as a compressible bladder which may be filled with at least one compressible medium, e.g., at least one gas, such as air or nitrogen. Thus, the at least one flexible member 26 may increase or decrease a volume of the at least one liquid receiving chamber 34 via compression or expansion of the at least one flexible member 26, as the liquid 20, or more liquid, flows into the at least one overflow device 22, more specifically into the at least one liquid receiving chamber 34.

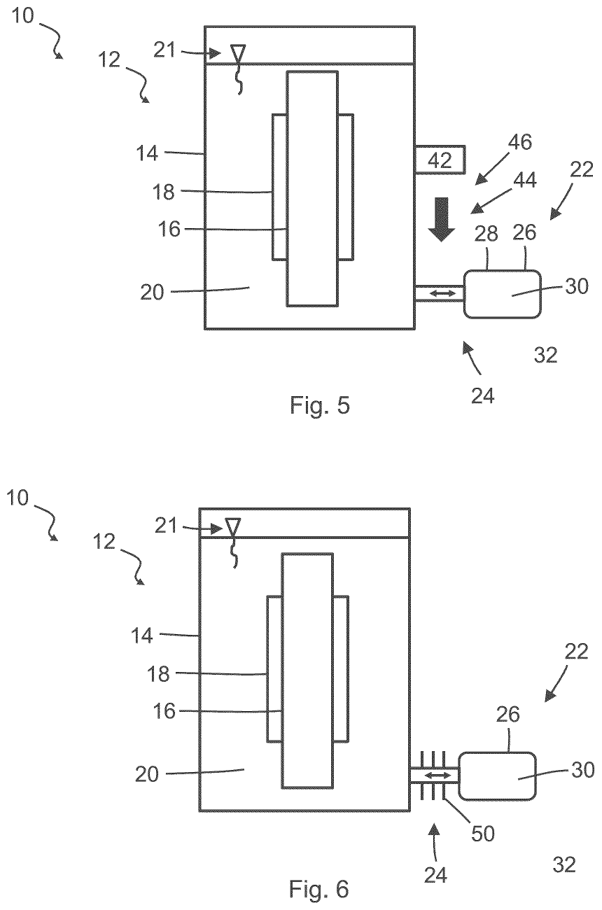

As shown in FIG. 5, the system 10 may include at least one heat transfer device 42 configured to provide at least one flow 44 of at least one cooling medium 46 at at least a portion of the at least one overflow device 22 and/or the connection device 24 to increase heat transfer from the liquid 20 therein to the at least one cooling medium 46. This may provide more favorable thermal conditions at the at least one overflow device 22, in particular the at least one flexible member 26. For instance, this may enable a greater flexibility in selecting a material for manufacturing the at least one flexible member 26. Many materials which are used to manufacture flexible and elastically deformable members are limited in their tolerance of increased temperatures. Thus, exposing the respective flexible member 26 to temperatures which are near or above the tolerance threshold temperature may result in damage and/or deterioration of the respective flexible member 26. Hence, decreasing the temperature of the liquid 20 by means of the at least one heat transfer device 42 may prevent, or at least reduce the risk of, damage to the at least one flexible member 26 and/or may increase the lifetime of the at least one flexible member 26.

The at least one heat transfer device 42 may be configured to generate a forced convection of the at least one flow 44. For instance, the system 10 may include one or more mechanical devices, e.g., at least one pump, at least one ventilator, at least one fan, at least one compressor, etc., configured to increase and/or decrease a pressure in the at least one cooling medium 46 to move the at least one cooling medium 46.

The system 10 may further include at least one guiding device configured to guide the at least one cooling medium 46 to at least a portion of the at least one overflow device 22 and/or the connection device 24. For instance, the at least one cooling medium 46 may be guided in at least one cooling circuit to and away from the connection device 24, as shown in FIG. 8. In general, the at least one guiding device may include any guiding structure configured to guide the at least one cooling medium 46 to at least a portion of the at least one overflow device 22 and/or the connection device 24. For instance, one or more plates and/or channels may be provided to guide the at least one cooling medium 46 to at least a portion of the at least one overflow device 22 and/or the connection device 24, e.g., by redirecting the at least one cooling medium 46.

According to the embodiment shown in FIG. 6, the system 10 may include one or more protrusions 50, in particular one or more fins, which may extend from at least one surface of the connection device 24. The one or more protrusions 50 may be configured to conduct heat to and/or from the connection device. Hence, the one or more protrusions 50 may increase an area of a heat transfer surface of the connection device 24 across which heat may be dissipated from the liquid 20 which may further reduce a temperature of the liquid 20. The system 10 according to the embodiment of FIG. 6 may be combined with one or more features of any of the other embodiments described herein, e.g., by including the at least one heat transfer device 42 shown in FIG. 5 and described above.

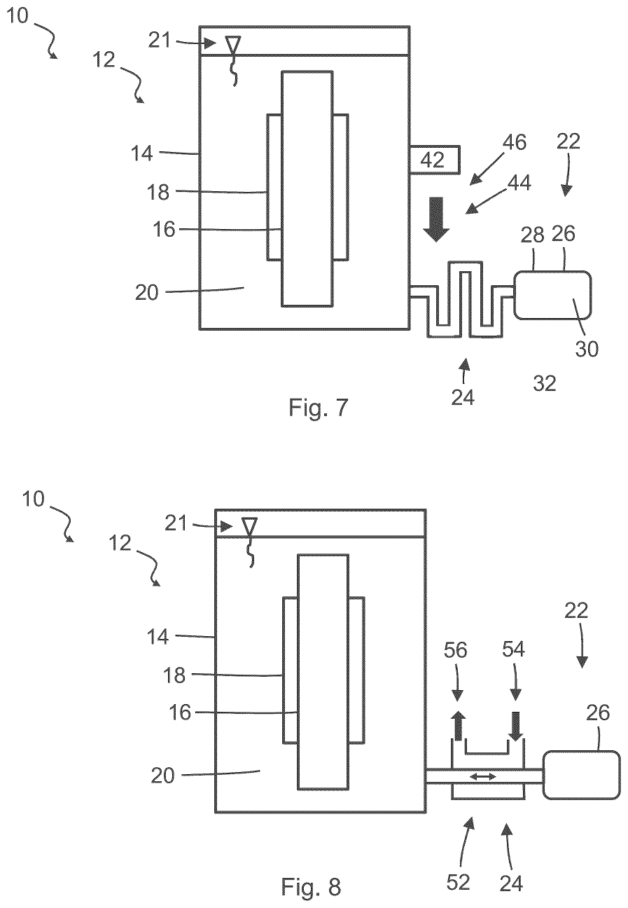

Alternatively, or additionally, the connection device 24 may be configured as a conduit which is guided in a coiled and/or meandering manner in at least a section thereof in order to increase an area of a heat transfer surface of the connection device 24 to further reduce a temperature of the liquid 20. An exemplary embodiment in which the connection device 24 is configured as a conduit which is guided in a meandering manner is shown in FIG. 7.

Alternatively, or additionally, the connection device 24 may be configured as a conduit which has a total effective length of at least 25 cm in order to increase an area of a heat transfer surface of the connection device 24 to further reduce a temperature of the liquid 20. For instance, the connection device 24 may be configured as a straight conduit which has a length of the at least 25 cm. Alternatively, the connection device 24 may be configured as a bent and/or curved conduit which has a total effective length of at least 25 cm. In order to provide a more compact conduit while providing a relatively long total effective length, the connection device 24 may be configured as a conduit which is guided in a coiled and/or meandering manner in at least a section thereof, as detailed above.

As shown in FIG. 8, the system 10 may include at least one cooling circuit 52 configured to guide the at least one cooling medium 46 to and away from the connection device 24 and/or the at least one overflow device 22. The cooling circuit 52 may include at least one cooling medium inlet 54 and at least one cooling medium outlet 56.

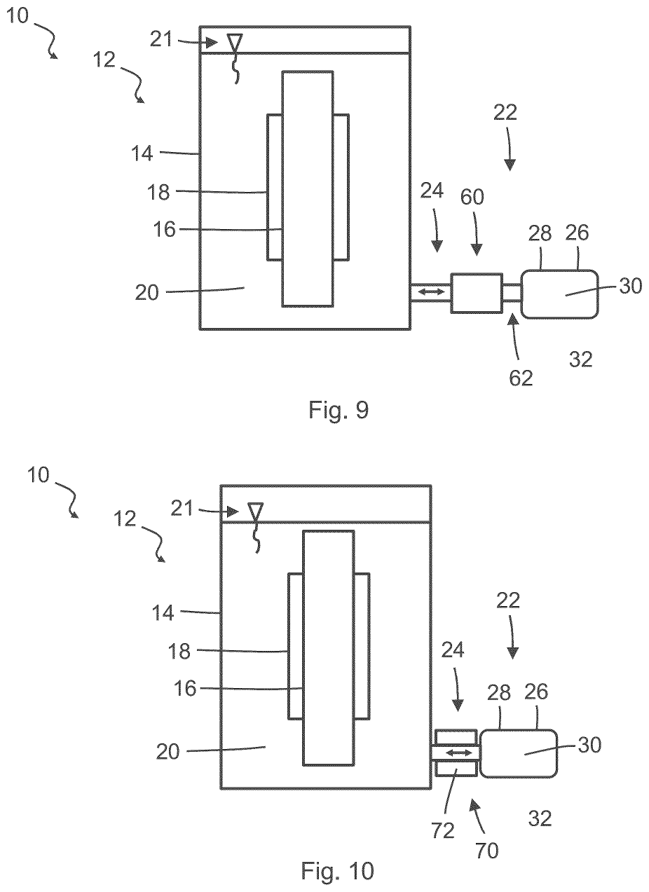

As shown in FIG. 9, the system 10 may include at least one buffer vessel 60 which is in fluidical connection with the at least one tank 14 and the at least one overflow device 22. The at least one buffer vessel 60 may be fluidically connected with the at least one tank 14 via the connection device 24 which may be configured or at least may include a conduit for guiding the liquid 20. The at least one buffer vessel 60 may be fluidically connected with the at least one overflow device 22 via a conduit 62.

The at least one buffer vessel 60 may be arranged such that the liquid 20 which is transferred from the at least one tank 14 to the at least one overflow device 22 is received by the at least one buffer vessel 60 before being received by the at least one overflow device 22.

As shown in FIG. 9, the system 10 may include at least one cooling device 70 configured to cool the liquid 20 via the connection device 24. The at least one cooling device 70 may be arranged in thermal communication with the connection device 24 to dissipate heat from the liquid 20 to the at least one cooling device 70. The at least one cooling device 70 may at least partially, in particular completely, surround the connection device 24.

The at least one cooling device 70 may include at least one cooling medium 72, wherein the at least one cooling device 70 may be configured to reduce a temperature of the at least one cooling medium 72 to a temperature which is below an ambient temperature. This may increase a temperature gradient between the liquid 20 and a heat sink, i.e., the at least one cooling medium 72 of the at least one cooling device 70. This may increase heat dissipation from the liquid 20.

The at least one cooling device 70 may include at least one phase-change material, e.g., as the at least one cooling medium 72. Alternatively, for instance, the at least one cooling device 70 may include a refrigerant circuit for cooling at least one cooling medium to a temperature which is below an ambient temperature.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A system, including:
at least one transformer which includes at least one tank configured to at least partially receive at least one liquid;
at least one overflow device and at least a first connection device configured to fluidically connect the at least one tank and the at least one overflow device, the at least one overflow device including at least one flexible member which is elastically deformable, the at least one overflow device being configured to periodically receive a portion of the liquid from the at least one tank under deformation of at least a portion of the at least one flexible member and return at least a portion of the received liquid to the at least one tank through the connection device; and
at least one heat transfer device configured to provide at least one flow of at least one cooling medium at at least a portion of the at least one overflow device and/or the connection device to increase heat transfer from the liquid therein to the cooling medium;
wherein the at least one flexible member provides a variable liquid storage volume in the at least one overflow device by being elastically deformed as the at least one overflow device receives liquid from the at least one tank to increase a liquid storage volume in the at least one overflow device.

2. The system according to claim 1, wherein the at least one heat transfer device is configured to convey the at least one cooling medium along the connection device in and/or against a direction in which the liquid is transferred from the at least one tank to the at least one overflow device.

3. The system according to claim 1, wherein the at least one heat transfer device includes at least one cooling circuit configured to guide the at least one cooling medium to and away from the connection device and/or the at least one overflow device.

4. The system according to claim 1, further including at least one guiding device configured to guide the at least one cooling medium to at least a portion of the at least one overflow device and/or the connection device.

5. A system, including:
at least one transformer which includes at least one tank configured to at least partially receive at least one liquid;
at least one overflow device and at least a first connection device configured to fluidically connect the at least one tank and the at least one overflow device, the at least one overflow device including at least one flexible member which is elastically deformable, the at least one overflow device being configured to periodically receive a portion of the liquid from the at least one tank under deformation of at least a portion of the at least one flexible member and return at least a portion of the received liquid to the at least one tank through the connection device; and
at least one surface increasing means configured to provide an increase in an area of a heat transfer surface of the connection device across which heat may be dissipated from the liquid by providing one or more of the following: one or more protrusions, in particular one or more fins, which extend from at least one surface of the connection device, configuring the connection device as a conduit which is guided in a coiled and/or meandering manner in at least a section thereof, and configuring the connection device as a conduit which has a total effective length of at least 25 cm;
wherein the at least one flexible member provides a variable liquid storage volume in the at least one overflow device by being elastically deformed as the at least one overflow device receives liquid from the at least one tank to increase a liquid storage volume in the at least one overflow device.

6. The system according to claim 5, wherein the conduit has a total effective length of at least 30 cm, more particularly at least 40 cm, more particularly at least 50 cm, more particularly at least 60 cm, more particularly at least 70 cm, more particularly at least 80 cm, more particularly at least 90 cm, more particularly at least 100 cm, more particularly at least 110 cm, more particularly at least 120 cm, more particularly at least 130 cm, more particularly at least 140 cm, more particularly at least 150 cm, more particularly at least 160 cm, more particularly at least 170 cm, more particularly at least 180 cm, more particularly at least 190 cm, more particularly at least 200 cm.

7. A system, including:
at least one transformer which includes at least one tank configured to at least partially receive at least one liquid;
at least one overflow device and at least a first connection device configured to fluidically connect the at least one tank and the at least one overflow device, the at least one overflow device including at least one flexible member which is elastically deformable, the at least one overflow device being configured to periodically receive a portion of the liquid from the at least one tank under deformation of at least a portion of the at least one flexible member and return at least a portion of the received liquid to the at least one tank through the connection device; and
at least one cooling device which includes at least one phase-change material, the at least one cooling device being arranged in thermal communication with the connection device liquid to dissipate heat from the liquid to the at least one phase-change material, when the liquid is received in the connection device;
wherein the at least one flexible member provides a variable liquid storage volume in the at least one overflow device by being elastically deformed as the at least one overflow device receives liquid from the at least one tank to increase a liquid storage volume in the at least one overflow device.

8. The system according to claim 7, wherein the at least one overflow device is configured such that, when at least a portion of the liquid is received by the at least one overflow device, the liquid is in direct contact with the flexible member.

9. The system according to claim 7, wherein the at least one flexible member is configured as a barrier between the liquid and an environment .

10. The system according to claim 7, wherein the at least one flexible member includes at least one flexible member wall which defines a lumen configured to receive at least a portion of the liquid from the at least one tank.

11. The system according to claim 7, wherein the at least one liquid includes an oil, in particular an insulating oil or an insulating ester fluid.

12. The system according to claim 7, wherein the connection device is fluidically connected to the at least one tank at a section of the at least one tank which is arranged to at least one side of the tank, in particular towards the bottom of the at least one tank.

13. The system according to claim 7, wherein the connection device is fluidically connected to the at least one tank at a section of the at least one tank which is arranged no higher than 50% of a liquid fill level of the at least one tank, in particular no higher than 40% of a liquid fill level of the at least one tank, in particular no higher than 30% of a liquid fill level of the at least one tank, in particular no higher than 20% of a liquid fill level of the at least one tank, in particular no higher than 10% of a liquid fill level of the at least one tank.

14. The system according to claim 7, further including at least one buffer vessel which is in fluidical connection with the at least one tank and the at least one overflow device, wherein the at least one buffer vessel is arranged such that the liquid which is transferred from the at least one tank to the at least one overflow device is received by the at least one buffer vessel before being received by the at least one overflow device.

15. The system according to claim 7, wherein the system, in particular at least the at least one overflow device and/or the connection device, is free of a hygroscopic substance, in particular a desiccant.
